(19) United States
(12) Patent Application Publication
(10) Pub. No.: US 2022/0414689 A1
(43) Pub. Date: Dec. 29, 2022

(54) METHOD AND APPARATUS FOR TRAINING PATH REPRESENTATION MODEL

(71) Applicant: Beijing Baidu Netcom Science Technology Co., Ltd., Beijing (CN)

(72) Inventors: Qi Zhang, Beijing (CN); Hengshu Zhu, Beijing (CN); Peng Wang, Beijing (CN); Hao Liu, Beijing (CN); Hui Xiong, Beijing (CN)

(21) Appl. No.: 17/900,649

(22) Filed: Aug. 31, 2022

(30) Foreign Application Priority Data
Jan. 19, 2022 (CN) 202210060612.4

(51) Int. Cl. G06Q 30/02; G06N 5/02

(52) U.S. Cl. CPC G06Q 30/0201; G06N 5/022

(57) ABSTRACT

A method and an apparatus for training a path representation model are provided. The method may include: acquiring at least one trajectory point of at least one user, where each trajectory point of each user includes a place passed by the user, a start time and a duration; inputting the at least one trajectory point of the at least one user into a pre-trained model to obtain a trajectory representation of each user; obtaining, for each user, a position of each trajectory point from the trajectory representation of the user by searching according to the start time and the duration of each trajectory point of the user; and adjusting a network parameter of the pre-trained model according to a difference between the place passed by each user and the position of each trajectory point obtained by searching, to obtain a path representation model.

### CROSS-REFERENCE TO RELATED APPLICATIONS

The present application claims the priority of Chinese Patent Application No. 202210060612.4, titled “METHOD AND APPARATUS FOR TRAINING PATH REPRESENTATION MODEL, AND METHOD AND APPARATUS FOR OUTPUTTING INFORMATION”, filed on Jan. 19, 2022, the content of which is incorporated herein by reference in its entirety.

### TECHNICAL FIELD

The present disclosure relates to the field of artificial intelligence, particularly to the field of big data analysis, and specifically to a method and apparatus for training a path representation model.

### BACKGROUND

Path representation (Trajectory Embedding) technology refers to a technology of transforming a motion path into a vector that can represent the characteristics of the path, and this vector can be used in various tasks related to a moving path. At present, with the rapid development of big data analysis technology, how to represent various kinds of information of people becomes the basis of data analyses and personalized services. Paths of people can fully reflect the movement and behavior models of the people, which is a very important aspect for information representation. For example, predicting the next movement of a person, estimating the identity of the person according to a behavior, etc., all require the representation information of the path.

### SUMMARY

The present disclosure provides a method and apparatus for training a path representation model, and a storage medium.

According to a first aspect of the disclosure, a method for training a path representation model is provided, which includes: acquiring at least one trajectory point of at least one user, where each trajectory point of each user includes a place passed by the user, a start time and a duration; inputting the at least one trajectory point of the at least one user into a pre-trained model to obtain a trajectory representation of each user; obtaining, for each user, a position of each trajectory point from the trajectory representation of the user by searching according to the start time and the duration of each trajectory point of each user; and adjusting a network parameter of the pre-trained model according to a difference between the place passed by each user and the position of each trajectory point obtained by searching, to obtain the path representation model.

According to a second aspect of the disclosure, an apparatus is provided, which includes at least one processor; and a storage device, in communication with the at least one processor, where the storage device stores instructions executable by the at least one processor, and the instructions are executed by the at least one processor, to enable the at least one processor to perform the method according to the first aspect.

According to a third aspect of the disclosure, a non-transitory computer readable storage medium is provided, where the computer instruction is used to cause a computer to perform the method according to the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a diagram of an example system architecture in which the present disclosure may be applied;

FIG. 2 is a flowchart of an embodiment of a method for training a path representation model according to the present disclosure;

FIGS. 3a and 3b are schematic diagrams of application scenarios of the method for training a path representation model according to the present disclosure;

FIG. 4 is a flowchart of an embodiment of a method for outputting information according to the present disclosure;

FIG. 5 is a schematic structural diagram of an embodiment of an apparatus for training a path representation model according to the present disclosure;

FIG. 6 is a schematic structural diagram of an embodiment of an apparatus for outputting information according to the present disclosure; and

FIG. 7 is a schematic structural diagram of a computer system of an electronic device adapted to implement the embodiments of the present disclosure.

### DETAILED DESCRIPTION OF EMBODIMENTS

Example embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

According to the method and apparatus for training a path representation model and the method and apparatus for outputting information that are provided in the embodiments of the present disclosure, a trajectory of a user whose position is not changed for a duration is transformed into the trajectory point including the place, the start time and the duration to perform modeling, and thus, the modeling efficiency can be improved and the semantic representation can be enhanced. The representation can be directly used for various analysis and prediction tasks, thus improving the accuracy of the prediction.

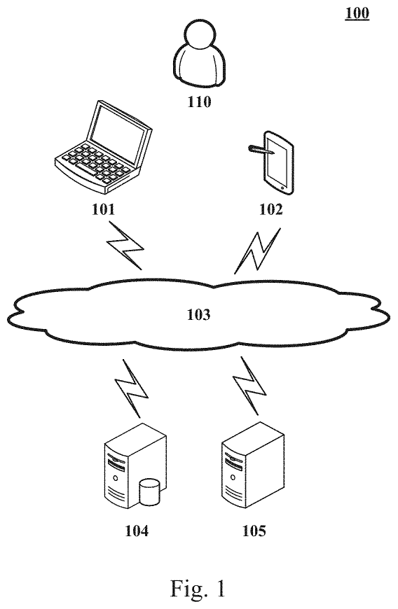

FIG. 1 illustrates an example system architecture 100 in which a method for training a path representation model, an apparatus for training a path representation model, a method for outputting information or an apparatus for outputting information according to an embodiment of the present disclosure may be applied.

As shown in FIG. 1, the system architecture 100 may include terminals 101 and 102, a network 103, a database server 104 and a server 105. The network 103 serves as a medium providing a communication link between the terminals 101 and 102, the database server 104 and the server 105. The network 103 may include various types of connections, for example, wired or wireless communication links, or optical fiber cables.

A user 110 may use the terminals 101 and 102 to interact with the server 105 via the network 103 to receive or send messages, etc. Various client applications (e.g., a model training application, a trajectory analysis application, a shopping application, a payment application, a webpage browser and an instant messaging tool) may be installed on the terminals 101 and 102.

Here, the terminals 101 and 102 may be hardware or software. When being the hardware, the terminals 101 and 102 may be various electronic devices having a wireless Internet access function, the electronic devices including, but not limited to, a smart phone, a tablet computer, an e-book reader, and an MP3 player (moving picture experts group audio layer III), a laptop portable computer, a desktop computer, and the like. When being the software, the terminals 101 and 102 may be installed in the listed electronic devices. The terminals 101 and 102 may be implemented as a plurality of pieces of software or a plurality of software modules (e.g., software or software modules for providing a distributed service), or as a single piece of software or a single software module, which will not be specifically limited here.

When being the hardware, the terminals 101 and 102 may further be provided with a wireless communication device. The wireless communication device may be a device supporting various wireless communication protocols such as wifi, nfc, rfid, bluetooth, and infrared. The wireless communication device on the terminals 101 and 102 may be utilized to collect trajectory points of the user 110.

The database server 104 may be a database server providing various services. For example, the database server may store a sample set. The sample set contains a large number of samples. Here, the samples may include sample trajectories and tags corresponding to the sample trajectories. In this way, the user 110 can also select a sample from the sample set stored in the database server 104 through the terminals 101 and 102.

The server 105 may alternatively be a server providing various services. For example, the server 105 may be a backend server providing support for various applications displayed on the terminals 101 and 102. The backend server may use the user trajectories collected by the terminals 101 and 102 to perform self-supervised training, to obtain an initial path representation model. Then, the backend server uses the samples to perform supervised training on the initial path representation model to obtain a fine-adjusted path representation model. Finally, the backend server sends the path representation model to the terminals 101 and 102, for the terminals 101 and 102 to perform a trajectory analysis. The backend server may alternatively save the path representation model locally, receive the trajectories sent by the terminals 101 and 102, and perform a trajectory analysis on the received trajectories.

Here, the database server 104 and the server 105 may also be hardware or software. When being the hardware, the database server 104 and the server 105 may be implemented as a distributed server cluster composed of a plurality of servers, or may be implemented as a single server. When being the software, the database server 104 and the server 105 may be implemented as a plurality of pieces of software or a plurality of software modules (e.g., software or software modules for providing a distributed service), or may be implemented as a single piece of software or a single software module, which will not be specifically defined here. The database server 104 and the server 105 may alternatively be servers of a distributed system, or servers combined with a blockchain. The database server 104 and the server 105 may alternatively be cloud servers, or intelligent cloud computing servers or intelligent cloud hosts with the artificial intelligence technology.

It should be noted that the method for training a path representation model or the method for outputting information provided in the embodiments of the present disclosure is generally performed by the server 105, and correspondingly, the apparatus for training a path representation model or the apparatus for outputting information is generally provided in the server 105.

It should be pointed out that, in the situation where the server 105 can implement the relevant functions of the database server 104, the database server 104 may not be provided in the system architecture 100.

It should be appreciated that the numbers of the terminals, the networks, the database servers, and the servers in FIG. 1 are merely illustrative. Any number of terminals, networks, database servers, and servers may be provided based on actual requirements.

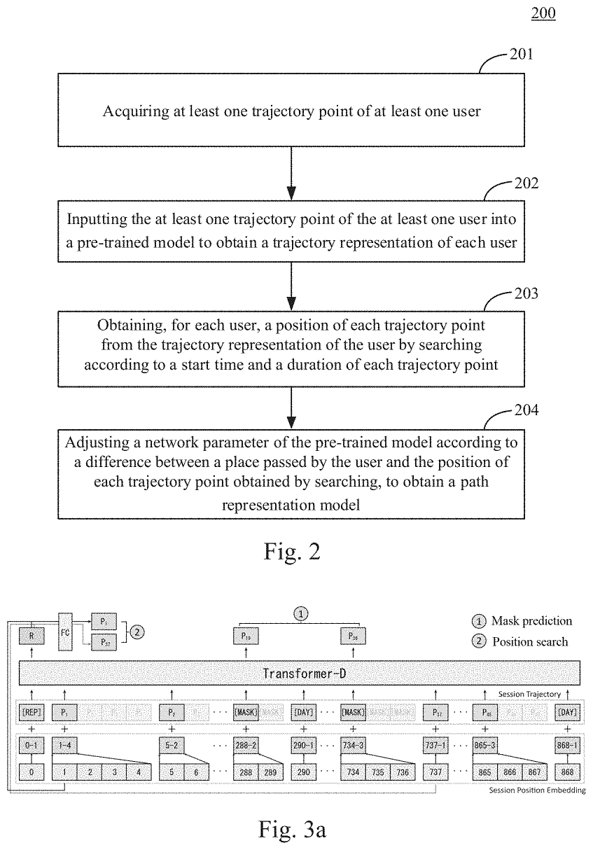

Further referring to FIG. 2, FIG. 2 illustrates a flow 200 of an embodiment of a method for training a path representation model according to the present disclosure. The method for training a path representation model may include the following steps.

Step 201 includes acquiring at least one trajectory point of at least one user.

In this embodiment, an executing body (e.g., the server 105 shown in FIG. 1) of the method for training a path representation model may acquire the trajectory information of the user by various means. The trajectory information may include a plurality of trajectory points. Here, each trajectory point of each user includes a place passed by the user, a start time and a duration.

The at least one trajectory point of the at least one user may be acquired from a log of a wireless access point. When the user stays near a wireless access point, the mobile communication device carried by the user accesses the nearby wireless access point. Therefore, the position of the wireless access point can reflect the position of the user within a certain range. In particular, in an indoor environment, a wireless access point accessed by the user can well reflect the area where the user is located. The log data of the wireless access point records device names and usernames accessed at different time points. Through this log, the positions of the user at different moments may be determined, and then, the moving trajectory of the user can be constructed. There may be different further processing schemes for the trajectories of different scenarios. For example, for a situation where the person indoors does not move frequently and often stays in a scene for a long time, a trajectory of the person whose position is not changed for a duration is transformed into a trajectory point including a place, a start time and the duration to perform modeling, and thus, the modeling efficiency can be improved and the semantic representation can be enhanced.

Alternatively, the at least one trajectory point of the at least one user may be acquired from a navigation log.

The acquisition for the trajectory point of the user is authorized by the user. For example, when the user sets an active connection to a wifi router, it represents that the wifi router is authorized to acquire the trajectory information of the user. In the present disclosure, the active access of the user can be anonymously processed, that is, only the trajectory of the user is distinguished, and no other information (e.g., the username and the gender) of the user is acquired.

Step 202 includes inputting the at least one trajectory point of the at least one user into a pre-trained model to obtain a trajectory representation of each user.

In this embodiment, a large number of unannotated trajectories are obtained using the data of the trajectory constructed by wireless access points. These trajectories are difficult to be used in a specific task, but contain a large number of common features of trajectories and relative position information of each access point. Therefore, in the present disclosure, a self-supervised pre-trained model is designed for the trajectory constructed by the wireless access points, such that the model learns these common information and generates a representation that can fully represent the trajectory information. For different data characteristics and demands, different model structures may be used, for example, a neural network model Transformer of a self-attention mechanism; or different time information encoding methods and different self-supervised training objectives may be used. For example, for an indoor scenario, the start time and the duration of each trajectory point may be simultaneously encoded using a position code in the form of a session, and a self-supervised objective may employ a masked prediction task and/or a position search task, of which one is used to learn a relationship between different time points and the other is used to make the information represented by the trajectory more comprehensive. After pre-training, common representations of each trajectory can be obtained, and these common representations may be directly used for various analysis and prediction tasks, or a fine adjustment may be further performed according to the annotation data of a target task to improve the task effect.

Step 203 includes obtaining, for each user, a position of each trajectory point of the user from the trajectory representation of the user by searching according to a start time and a duration of each trajectory point.

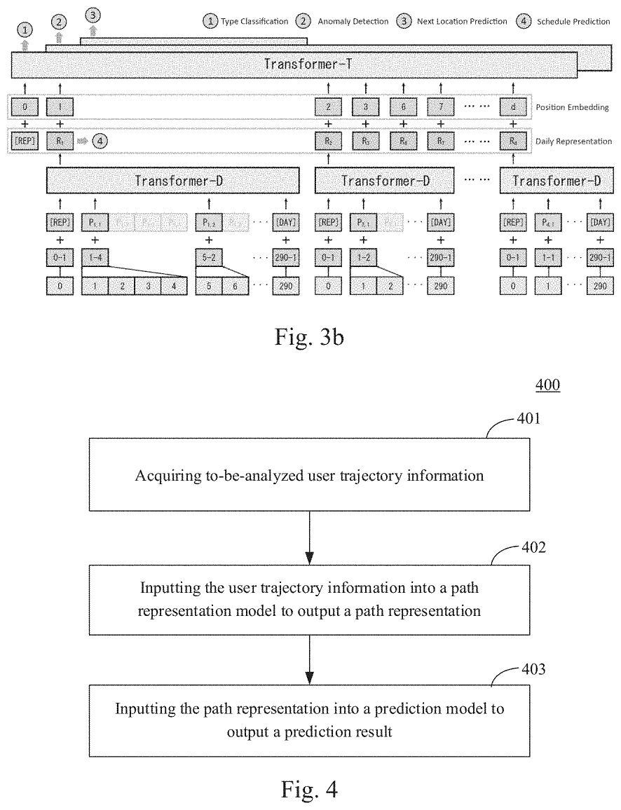

In this embodiment, as shown in FIG. 3a, a framework in a pre-training phase is shown, where Session Trajectory is a trajectory sequence of wireless access points for which continuous points in a same place are merged, Session Position Embedding refers to a position code in the form of a session, and a start time and a duration are simultaneously encoded. Transformer-D is a replaceable pre-trained model. R represents a trajectory representation generated in the pre-training phase. FC is a fully connected layer, \textcircled{1} is a masked code prediction task, predicting a position covered by [MASK], and \textcircled{2} is a position search task. In this embodiment, the prediction time codes “1-4” and “737-1” of the start time and the duration are inputted. The positions P₁ and P₃₇ of a person within the duration represented by the two prediction time codes are searched for.

Step 204 includes adjusting a network parameter of the pre-trained model according to a difference between a place passed by each user and the position of each trajectory point obtained by searching, to obtain a path representation model.

In this embodiment, the position search task is used as a supervision objective to implement self-supervised training. That is, the place passed by the user is equivalent to a true value, and the position of each trajectory point obtained by searching is equivalent to a predicted value. According to the difference between the true value and the predicted value, a loss value can be calculated. Then, the network parameter of the pre-trained model is adjusted according to the loss value to obtain the path representation model. The network parameter of the pre-trained model is continuously adjusted according to the position search result until the loss value is smaller than a predetermined threshold value, thus completing the training for the path representation model.

According to the above embodiment, the trajectory of a user whose position is not changed for a duration is transformed into the trajectory point including the place, the start time and the duration to perform modeling, and thus, the modeling efficiency can be improved and the semantic representation can be enhanced. The representation may be directly used for various analysis and prediction tasks, thus improving the accuracy of the prediction.

In some alternative implementations of this embodiment, the method further includes: masking, according to a masking rule, places passed by the user in a part of the at least one trajectory point of the at least one user, to obtain at least one masked trajectory point; inputting the at least one masked trajectory point into the pre-trained model to obtain a mask position; and adjusting a network parameter of the pre-trained model according to a difference between the mask position and the masking rule, to obtain the path representation model. The masking rule is used to specify the place in a trajectory point for masking, leaving only the start time and the duration when the user passes through the place, thus obtaining the at least one masked trajectory point (having no place, but having a start time and a duration), as shown by MASK in FIG. 3a. The pre-trained model may predict the masked place (i.e., the mask position) according to the start time and the duration of the masked trajectory point. According to the predicted mask position (i.e., the predicted value) and the position (i.e., the true value) actually masked according to the masking rule, the loss value of the pre-trained model may be calculated. Then, the network parameter of the pre-trained model is adjusted according to the loss value to obtain the path representation model. The network parameter of the pre-trained model is continuously adjusted according to the position search result until the loss value is smaller than the predetermined threshold value, thus completing the training for the path representation model.

Here, two tasks are involved: the position search task and the masked code prediction task. Each task corresponds to one loss value, and the weighted sum of the two loss values may be used as a total loss value. The network parameter of the pre-trained model is adjusted through the gradient descent and back propagation of the total loss value, until the total loss value is smaller than a predetermined threshold value, thus completing the training for the path representation model.

By performing the self-supervised training on the path representation model through two kinds of self-supervision tasks, the convergence speed of the model can be accelerated, and the accuracy of the model can be improved. In addition, the model can further be used to predict the position of the user in a specified period of time.

In some alternative implementations of this embodiment, the method further includes: acquiring a sample set, a sample in the sample set including a sample trajectory and a tag; and using respectively the sample trajectory and the tag in the sample set as an input and an expected output of the path representation model, to perform supervised training on the path representation model.

After the pre-training, if there is relevant annotation data (i.e., a sample set) of a task objective, the annotation data may be used to further perform a fine adjustment on the model parameter. If the path length required by the target task is within the acceptable range in the amount of calculation, the pretrained model may be directly used to perform the fine adjustment. The tag in the sample set may be a self-supervision objective (a position search and a mask prediction) or other objectives, for example, a path category tag, an abnormal event tag, a next position tag, and a schedule tag. The accuracy of the path representation model is further improved through supervised training, and a plurality of tasks may further be implemented using the path representation outputted by the model, e.g., predicting a path category, an abnormal event, a next position and a schedule according to the trajectory.

In some alternative implementations of this embodiment, the method further includes: dividing, for a target sample trajectory with a total duration exceeding a predetermined value in the sample set, the target sample trajectory into at least one segment according to a predetermined time interval; inputting, for each target sample trajectory, at least one segment of the target sample trajectory into the path representation model to obtain a representation of each segment of the target sample trajectory; and constructing, for each target sample trajectory, the representation of each segment into a sequence of representations for the target sample trajectory, and inputting the sequence and a time identifier corresponding to each segment into a sequence model, to output a representation sequence of the target sample trajectory.

If the path length required by the target task is excessively long (i.e., the total duration exceeds the predetermined value, e.g., 1 week), or the data must have a very strong periodicity, a multi-level model structure may be used. Specifically, the inputted sequence may be divided into segments according to the periodicity of the data itself, for example, divided into segments at intervals of days. The segments are then inputted into the pre-trained model to obtain the representation of each segment. Then, the representations are constructed into a sequence, the new constructed sequence is inputted into a sequence model having a new parameter, and finally, the representation of the whole sequence is outputted. This representation may be used for the analysis and prediction on the target task. This method can improve the efficiency, enhance the expression of periodic information, and at the same time, can flexibly cope with the inputted sequences of different lengths.

FIG. 3b shows how to train a new multi-level model by performing a fine adjustment based on the pre-trained model. Different segments of trajectories may be transformed into representations through the pre-trained model, and these representations may constitute a new sequence. If a segment length is one day, the representation refers to Daily Representation, time information Position Embedding (i.e., a time identifier, for example, first day, and second day) is added for this new representation. Finally, the representation of the full path is obtained through a high-level model Transformer-T with new parameters, to be applied to various tasks, for example, \textcircled{1} Type Classification (path category), \textcircled{2} Anomaly Detection, \textcircled{3} Next Location Prediction and \textcircled{4} Schedule Prediction. \textcircled{1} represents a path classification task, which is a universal task, and has different correspondences in different scenarios, for example, a classification of customer categories, and potential attributes of users. \textcircled{2} represents an anomaly detection task, which refers to that an abnormal event in a path may be detected to find a risk or a special event worthy of attention, for example, abnormal behavior of a student, and an abnormal action of a customer. \textcircled{3} represents a next location prediction task, which is used to predict a next destination of the user. \textcircled{4} represents a schedule prediction task, which is used to predict a destination of the user within a specified time. If the sample tag is marked with the path category, abnormal event, next location and schedule of the user that correspond to the sample trajectory, a fine-adjusted multi-level model may be obtained by learning the features of the sample trajectory through the supervised training process, and thus can be used to predict the above four tasks.

In this embodiment, a widely existing wireless access point device is utilized to make a large scale of path representations possible. At the same time, the pre-trained model is designed according to the characteristics of the path data, to make full use of the unannotated data to learn the common representation, and thus, the pre-trained model can be flexibly applied to various tasks. Further, the path representation model is designed, and thus, the effect can be improved by using the annotation data of the target task. Here, the multi-level model structure may enhance the periodic expression, and reduce exponentially the required amount of computation and the required computational space in the case of long sequences (may be reduced by about 100-200 times in the case of the length of 8000).

In some alternative implementations of this embodiment, the method further includes: outputting the sequence representation of each target sample trajectory by a prediction model, to obtain a prediction result of each target sample trajectory; and adjusting a network parameter of the sequence model according to a difference between the prediction result of each target sample trajectory and a tag corresponding to each target sample trajectory. The path representation model may be continuously optimized according to the prediction result. This method may alternatively be an actual application method of the path representation model generated in the above embodiment. The path representation model generated in the above embodiments is used to transform the trajectory point into the path representation in the form of vectors, which helps improving the performance of the path representation and reduce the amount of computation and the computational space.

In some alternative implementations of this embodiment, the tag includes at least one of: a path category tag, an abnormal event tag, a next position tag, or a schedule tag. Each tag corresponds to the task in FIG. 3b. The path category tag is used as a true value of a path category prediction task. For example, the trajectories of users who visit a mother-infant user store are collected and added with a path category tag “mother and infant.” The abnormal event tag is used as the true value of an abnormal event prediction task. For example, the trajectories of users who have a theft behavior are collected and added with a tag “theft.” The next location tag is used as the value of the next location prediction task. For example, the trajectories of users whose next location is a meeting room are collected and added with a tag “meeting room.” The schedule tag is used as the true value of the schedule task. For example, the trajectories of users who worked overtime the night before and went to a meeting room the next morning are added with a tag “having a meeting the next day.” Using samples of various tags can improve the convergence speed of the model, improve the accuracy of the model, and expand the application scenarios of the model.

Referring to FIG. 4, FIG. 4 illustrates a flow 400 of an embodiment of a method for outputting information provided in the present disclosure. The method for outputting information may include the following steps.

Step 401 includes acquiring to-be-analyzed user trajectory information.

In this embodiment, an executing body (e.g., the server 105 shown in FIG. 1) of the method for outputting information may acquire the trajectory information of a testing object by various means. As an example, the executing body may acquire, from a database server (e.g., the database server 104 shown in FIG. 1), the trajectory information stored in the database server, by means of a wired connection or a wireless connection. As another example, the executing body may alternatively receive the trajectory information collected by a terminal (e.g., the terminals 101 and 102 shown in FIG. 1) or another device. The testing object is a user authorizing the server to perform a trajectory analysis. The trajectory information includes a place passed by the user, a start time, and a duration. The trajectory information may be acquired by extracting a wireless access log, or may be acquired through other positioning methods.

Step 402 includes inputting the user trajectory information into a path representation model to output a path representation.

In this embodiment, the executing body may input the user trajectory information acquired in step 401 into the path representation model, thereby generating the path representation of the testing object. The path representation may be a vector used to describe a trajectory. For example, the path representation may include places passed by the user, the time reaching the places, and the durations for staying in the places.

In this embodiment, the path representation model may be generated using the method as described in the above embodiment of the FIG. 2. For the specific generation process, reference may be made to the relevant description of the embodiment of the FIG. 2, and thus, the details will not be repeatedly described here.

Step 403 includes inputting the path representation into a prediction model to output a prediction result.

In this embodiment, the prediction model may be a classifier, or a fully connected layer. The prediction model is configured to classify the path representation, and categories may be set according to sample tags, for example, categories of paths (mother and infant, sports products, etc.), and categories of abnormal events (theft, secret photography, etc.).

It should be noted that the method for outputting information in this embodiment may be used to test the path representation model generated in the above embodiments. Then, according to the prediction result, the path representation model can be continuously optimized. This method may alternatively be an actual application method of the path representation model generated in the above embodiments. The path representation model generated in the above embodiments is used to perform the trajectory analysis, which helps improving the accuracy of the trajectory analysis.

In some alternative implementations of this embodiment, the prediction result includes at least one of: a path category, an abnormal event, a next position, or a schedule. Accordingly, the path representation model may have a wide range of application scenarios, for example, recommending paths for users, helping to manage human resources, and analyzing user behaviors for a security protection.

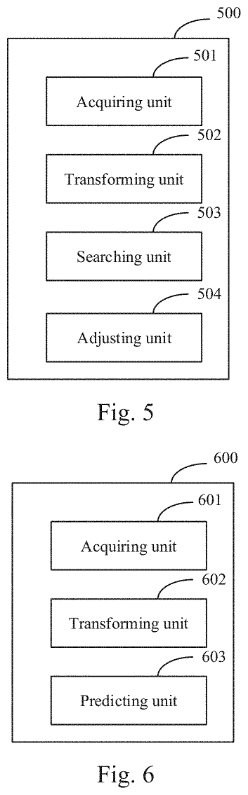

Further referring to FIG. 5, as an implementation of the above method shown in FIG. 2, the present disclosure provides an embodiment of an apparatus for training a path representation model. The embodiment of the apparatus corresponds to the embodiment of the method shown in FIG. 2, and the apparatus may be applied in various electronic devices.

As shown in FIG. 5, an apparatus 500 for training a path representation model in this embodiment may include: an acquiring unit 501, a transforming unit 502, a searching unit 503 and an adjusting unit 504. Here, the acquiring unit 501 is configured to acquire at least one trajectory point of at least one user, where each trajectory point of each user includes a place passed by the user, a start time and a duration. The transforming unit 502 is configured to input the at least one trajectory point of the at least one user into a pre-trained model to obtain a trajectory representation of each user. The searching unit 503 is configured to obtain, for each user, a position of each trajectory point from the trajectory representation of the user by searching according to the start time and the duration of each trajectory point of the user. The adjusting unit 504 is configured to adjust a network parameter of the pre-trained model according to a difference between the place passed by each user and the position of each trajectory point obtained by searching, to obtain a path representation model.

In some alternative implementations of this embodiment, the apparatus 500 further includes a training unit (not shown). The training unit is configured to: acquire a sample set, a sample in the sample set including a sample trajectory and a tag; and use respectively the sample trajectory and the tag in the sample set as an input and an expected output of the path representation model, to perform supervised training on the path representation model.

In some alternative implementations of this embodiment, the transforming unit 502 is further configured to: divide, for a target sample trajectory with a total duration exceeding a predetermined value in the sample set, the target sample trajectory into at least one segment according to a predetermined time interval; input, for each target sample trajectory, at least one segment of the target sample trajectory into the path representation model to obtain a representation of each segment of the target sample trajectory; and construct, for each target sample trajectory, the representation of each segment into a sequence of representations of the target sample trajectory, and input the sequence and a time identifier corresponding to each segment into a sequence model, to output a sequence of representations of the target sample trajectory.

In some alternative implementations of this embodiment, the training unit is further configured to: output the sequence of representations of each target sample trajectory by a prediction model, to obtain a prediction result of each target sample trajectory; and adjust a network parameter of the prediction model according to a difference between the prediction result of each target sample trajectory and a tag corresponding to each target sample trajectory.

In some alternative implementations of this embodiment, the tag includes at least one of: a path category tag, an abnormal event tag, a next position tag, or a schedule tag.

In some alternative implementations of this embodiment, the apparatus 500 further includes a masking unit (not shown). The masking unit is configured to: mask according to a masking rule, places passed by the user in a part of the at least one trajectory point of the at least one user, to obtain at least one masked trajectory point; input the at least one masked trajectory point into the pre-trained model to obtain a mask position; and adjust a network parameter of the pre-trained model according to a difference between the mask position and the masking rule, to obtain the path representation model.

Further referring to FIG. 6, as an implementation of the above method shown in FIG. 4, the present disclosure provides an embodiment of an apparatus for outputting information. The embodiment of the apparatus corresponds to the embodiment of the method shown in FIG. 4, and the apparatus may be applied in various electronic devices.

As shown in FIG. 6, an apparatus 600 for outputting information in this embodiment may include: an acquiring unit 601, a transforming unit 602, and a predicting unit 603. Here, the acquiring unit 601 is configured to acquire to-be-analyzed user trajectory information. The transforming unit 602 is configured to input the user trajectory information into the path representation model generated by the apparatus 500, to output a path representation. The predicting unit 603 is configured to input the path representation into a prediction model to output a prediction result.

In some alternative implementations of this embodiment, the prediction result includes at least one of: a path category, an abnormal event, a next position, or a schedule.

In the technical solution of the present disclosure, the collection, storage, use, processing, transmission, provision, disclosure, etc. of the personal information of a user all comply with the provisions of the relevant laws and regulations, and do not violate public order and good customs.

According to an embodiment of the present disclosure, the present disclosure further provides an electronic device, a readable storage medium, and a computer program product.

An electronic device includes at least one processor, and a storage device in communication with the at least one processor. Here, the storage device stores instructions executable by the at least one processor, and the instructions are executed by the at least one processor, to enable the at least one processor to perform the method according to the flow 200 or 400.

A non-transitory computer readable storage medium stores a computer instruction. Here, the computer instruction is used to cause a computer to perform the method according to the flow 200 or 400.

A computer program product includes a computer program. The computer program, when executed by a processor, implements the method according to the flow 200 or 400.

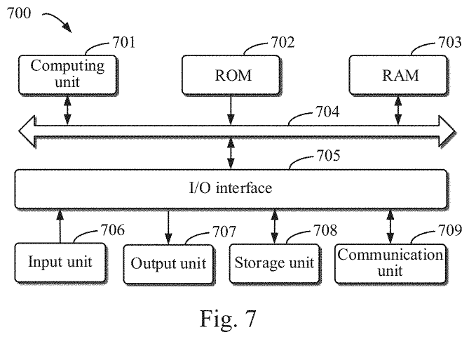

FIG. 7 is a schematic block diagram of an example electronic device 700 that may be adapted to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital assistant, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 7, the device 700 includes a computing unit 701, which can perform various appropriate actions and processes according to a computer program stored in a read only memory (ROM) 702 or a computer program loaded from the storage unit 708 into a random access memory (RAM) 703. In RAM 703, various programs and data required for the operation of device 700 can also be stored. The computing unit 701, ROM 702, and RAM 703 are connected to each other through a bus 704. Input/output (I/O) interface 705 is also connected to bus 704.

A plurality of components in the device 700 are connected to the I/O interface 705, including: an input unit 706, such as a keyboard, a mouse, etc.; an output unit 707, such as various types of displays, speakers, and the like; a storage unit 708, such as a magnetic disk, an optical disk, and the like; and a communication unit 709, such as a network card, a modem, a wireless communication transceiver, and the like. The communication unit 709 allows the device 700 to exchange information/data with other devices through computer networks such as the Internet and/or various telecommunication networks.

The computing unit 701 may be various general-purpose and/or special-purpose processing components with processing and computing capabilities. Some examples of the computing unit 701 include, but are not limited to, a central processing unit (CPU), a graphics processing unit (GPU), various dedicated artificial intelligence (AI) computing chips, various computing units that run machine learning model algorithms, digital signal processors (DSPS), and any appropriate processors, controllers, microcontrollers, and the like. The calculation unit 701 performs the various methods and processes described above, such as a method for training a path representation model. For example, in some embodiments, the method for training a path representation model may be implemented as a computer software program that is tangibly contained in a machine-readable medium, such as a storage unit 708. In some embodiments, part or all of the computer program may be loaded and/or installed on the device 700 via ROM 702 and/or communication unit 709. When the computer program is loaded into RAM 703 and executed by the computing unit 701, one or more steps of the method for training a path representation model described above may be performed. Alternatively, in other embodiments, the computing unit 701 may be configured to perform the method for training a path representation model by any other suitable means (e.g., by means of firmware).

Various embodiments of the systems and technologies described above in this paper can be implemented in digital electronic circuit systems, integrated circuit systems, field programmable gate arrays (FPGAs), application specific integrated circuits (ASIC), application specific standard products (ASSP), system on chip (SOC), load programmable logic devices (CPLD), computer hardware, firmware, software, and/or combinations thereof. These various embodiments may include: being implemented in one or more computer programs, the one or more computer programs can be executed and/or interpreted on a programmable system including at least one programmable processor, which can be a special-purpose or general-purpose programmable processor, and can receive data and instructions from the storage system, at least one input device, and at least one output device, and transmitting data and instructions to the storage system, the at least one input device, and the at least one output device.

The program code for implementing the methods of the present disclosure may be written in any combination of one or more programming languages. These program codes can be provided to the processor or controller of general-purpose computer, special-purpose computer or other programmable data processing device, so that when the program code is executed by the processor or controller, the functions/operations specified in the flow chart and/or block diagram are implemented. The program code can be completely executed on the machine, partially executed on the machine, partially executed on the machine and partially executed on the remote machine as a separate software package, or completely executed on the remote machine or server.

In the context of the present disclosure, a machine-readable medium may be a tangible medium that may contain or store a program for use by or in combination with an instruction execution system, apparatus, or device. The machine-readable medium can be a machine-readable signal medium or a machine-readable storage medium. Machine readable media may include, but are not limited to, electronic, magnetic, optical, electromagnetic, infrared, or semiconductor systems, apparatuses, or devices, or any suitable combination of the foregoing. More specific examples of machine-readable storage media may include one or more wire based electrical connections, portable computer disks, hard disks, random access memory (RAM), read only memory (ROM), erasable programmable read only memory (EPROM or flash memory), optical fibers, compact disk read only memory (CD-ROM), optical storage devices, magnetic storage devices, or any suitable combination of the above.

In order to provide interaction with users, the systems and techniques described herein can be implemented on a computer with: a display device for displaying information to users (for example, a CRT (cathode ray tube) or LCD (liquid crystal display) monitor); and a keyboard and a pointing device (e.g., a mouse or a trackball) through which the user can provide input to the computer. Other kinds of devices can also be used to provide interaction with users. For example, the feedback provided to the user may be any form of sensor feedback (e.g., visual feedback, auditory feedback, or tactile feedback); and the input from the user can be received in any form (including acoustic input, voice input or tactile input).

The systems and techniques described herein may be implemented in a computing system including background components (e.g., as a data server), or a computing system including middleware components (e.g., an application server) or a computing system including a front-end component (e.g., a user computer with a graphical user interface or a web browser through which a user can interact with embodiments of the systems and techniques described herein), or a computing system including any combination of the back-end component, the middleware component, the front-end component. The components of the system can be interconnected by digital data communication (e.g., communication network) in any form or medium. Examples of communication networks include local area networks (LANs), wide area networks (WANs), and the Internet.

A computer system may include a client and a server. The client and the server are generally far away from each other and usually interact through communication networks. The relationship between the client and the server is generated by computer programs running on the corresponding computers and having a client server relationship with each other. The server can be a cloud server, a distributed system server, or a blockchain server.

It should be understood that various forms of processes shown above can be used to reorder, add or delete steps. For example, the steps recorded in the present disclosure can be performed in parallel, in sequence, or in different orders, as long as the desired results of the technical solution of the present disclosure can be achieved, which is not limited herein.

The above specific embodiments do not constitute restrictions on the scope of the present disclosure. Those skilled in the art should understand that various modifications, combinations, sub combinations and substitutions can be made according to design requirements and other factors. Any modification, equivalent replacement and improvement made within the spirit and principles of this disclosure shall be included in the scope of protection of this disclosure.

What is claimed is:

1. A method for training a path representation model, comprising:
acquiring at least one trajectory point of at least one user, wherein each trajectory point of each user comprises a place passed by the each user, a start time and a duration;
inputting the at least one trajectory point of the at least one user into a pre-trained model to obtain a trajectory representation of each user;
obtaining, for each user, a position of each trajectory point from the trajectory representation of the user by searching according to the start time and the duration of each trajectory point of the each user; and
adjusting a network parameter of the pre-trained model according to a difference between the place passed by the each user and the position of the each trajectory point obtained by searching, to obtain the path representation model.

2. The method according to claim 1, further comprising:
acquiring a sample set, a sample in the sample set comprising a sample trajectory and a tag; and
using respectively the sample trajectory and the tag in the sample set as an input and an expected output of the path representation model, to perform supervised training on the path representation model.

3. The method according to claim 2, further comprising:
dividing, for a target sample trajectory with a total duration exceeding a predetermined value in the sample set, the target sample trajectory into at least one segment according to a predetermined time interval;
inputting, for each target sample trajectory, at least one segment of the target sample trajectory into the path representation model to obtain a representation of each segment of the target sample trajectory; and
constructing, for each target sample trajectory, the representation of each segment into a sequence of representations of the target sample trajectory, and inputting the sequence and a time identifier corresponding to each segment into a sequence model, to output a sequence representation of the target sample trajectory.

4. The method according to claim 3, further comprising:
outputting the sequence representation of each target sample trajectory by a prediction model, to obtain a prediction result of the each target sample trajectory; and
adjusting a network parameter of the sequence model according to a difference between the prediction result of the each target sample trajectory and a tag corresponding to the each target sample trajectory.

5. The method according to claim 2, wherein the tag comprises at least one of: a path category tag, an abnormal event tag, a next position tag, or a schedule tag.

6. The method according to claim 1, further comprising:
masking, according to a masking rule, places passed by the user in a part of the at least one trajectory point of the at least one user, to obtain at least one masked trajectory point;
inputting the at least one masked trajectory point into the pre-trained model to obtain a mask position; and
adjusting a network parameter of the pre-trained model according to a difference between the mask position and the masking rule, to obtain the path representation model.

7. The method according to claim 1, comprising:
acquiring to-be-analyzed user trajectory information;
inputting the user trajectory information into the path representation model, to output a path representation; and
inputting the path representation into a prediction model to output a prediction result.

8. The method according to claim 7, wherein the prediction result comprises at least one of: a path category, an abnormal event, a next position, or a schedule.

9. An apparatus for training a path representation model, comprising:
at least one processor; and
a storage device, wherein the storage device stores instructions executable by the at least one processor, and the instructions when executed by the at least one processor cause the at least one processor to perform operations comprising:
acquiring at least one trajectory point of at least one user, wherein each trajectory point of each user comprises a place passed by the each user, a start time and a duration;
inputting the at least one trajectory point of the at least one user into a pre-trained model to obtain a trajectory representation of each user;
obtaining, for each user, a position of each trajectory point from the trajectory representation of the user by searching according to the start time and the duration of each trajectory point of the each user; and
adjusting a network parameter of the pre-trained model according to a difference between the place passed by the each user and the position of the each trajectory point obtained by searching, to obtain the path representation model.

10. The apparatus according to claim 9, wherein the operations further comprise:
acquiring a sample set, a sample in the sample set comprising a sample trajectory and a tag; and
using respectively the sample trajectory and the tag in the sample set as an input and an expected output of the path representation model, to perform supervised training on the path representation model.

11. The apparatus according to claim 10, wherein the operations further comprise:
dividing, for a target sample trajectory with a total duration exceeding a predetermined value in the sample set, the target sample trajectory into at least one segment according to a predetermined time interval;
inputting, for each target sample trajectory, at least one segment of the target sample trajectory into the path representation model to obtain a representation of each segment of the target sample trajectory; and
constructing, for each target sample trajectory, the representation of each segment into a sequence of representations of the target sample trajectory, and input the sequence and a time identifier corresponding to each segment into a sequence model, to output a sequence representation of the target sample trajectory.

12. The apparatus according to claim 11, wherein the operations comprise:
outputting the sequence representation of each target sample trajectory by a prediction model, to obtain a prediction result of the each target sample trajectory; and
adjusting a network parameter of the sequence model according to a difference between the prediction result of the each target sample trajectory and a tag corresponding to the each target sample trajectory.

13. The apparatus according to claim 10, wherein the tag comprises at least one of: a path category tag, an abnormal event tag, a next position tag, or a schedule tag.

14. The apparatus according to claim 9, wherein the operations further comprise:
masking, according to a masking rule, places passed by the user in a part of the at least one trajectory point of the at least one user, to obtain at least one masked trajectory point;
inputting the at least one masked trajectory point into the pre-trained model to obtain a mask position; and
adjusting a network parameter of the pre-trained model according to a difference between the mask position and the masking rule, to obtain the path representation model.

15. The apparatus according to claim 9, wherein the operations further comprise:
acquiring to-be-analyzed user trajectory information;
inputting the user trajectory information into the path representation model, to output a path representation; and
a predicting unit, configured to input the path representation into a prediction model to output a prediction result.

16. The apparatus according to claim 15, wherein the prediction result comprises at least one of: a path category, an abnormal event, a next position, or a schedule.

17. A non-transitory computer readable storage medium, storing a computer instruction, wherein the computer instruction when executed by a computer causes the computer to perform operations comprising:
acquiring at least one trajectory point of at least one user, wherein each trajectory point of each user comprises a place passed by the each user, a start time and a duration;
inputting the at least one trajectory point of the at least one user into a pre-trained model to obtain a trajectory representation of each user;
obtaining, for each user, a position of each trajectory point from the trajectory representation of the user by searching according to the start time and the duration of each trajectory point of the each user; and
adjusting a network parameter of the pre-trained model according to a difference between the place passed by the each user and the position of the each trajectory point obtained by searching, to obtain the path representation model.
